(19) United States
(12) Patent Application Publication
(10) Pub. No.: US 2026/0084623 A1
(43) Pub. Date: Mar. 26, 2026

(54) VEHICLE DECK BOARD AND LEG MEMBER THEREOF

(71) Applicants: HAYASHI TELEMPU CORPORATION, Nagoya-shi (JP); NIFCO INC., Yokosuka-shi (JP)

(72) Inventors: Kunihiko SUGIYAMA, Nagoya-shi (JP); Suguru UTSUNOMIYA, Nagoya-shi (JP); Hiroki TAGUCHI, Kariya-shi (JP); Ryuuji ISHIKAWA, Kariya-shi (JP); Misato NIIZEKI, Yokosuka-shi (JP)

(21) Appl. No.: 19/337,904

(22) Filed: Sep. 24, 2025

(30) Foreign Application Priority Data
Sep. 25, 2024 (JP) 2024-166206

(51) Int. Cl. B60R 5/04

(52) U.S. Cl. CPC B60R 5/045

(57) ABSTRACT

A vehicle deck board includes: a deck board body having a placement surface for luggage, the deck board body having a back surface opposite to the placement surface; a leg body (part of leg member) having a base end part rotatably connected to the deck board body around a rotation axis along the back surface, the leg body having a tip end part on a side opposite to the base end part, the leg body being rotatable between a storage position along the back surface and an upright position erected from the back surface; and a floor lock mechanism (part of leg member) located at the tip end part of the leg body, the floor lock mechanism being configured to releasably lock the leg body to the floor when the leg body at the upright position is placed on a floor of a luggage compartment of a vehicle.

### CROSS-REFERENCE TO RELATED APPLICATION

The present application is related to the Japanese Patent Application No. 2024-166206, filed Sep. 25, 2024, the entire disclosure of which is expressly incorporated by reference herein.

### FIELD OF THE INVENTION

The present invention relates to a vehicle deck board to be disposed in a luggage compartment of a vehicle, and a leg member thereof.

### DESCRIPTION OF RELATED ART

Automotive deck boards are used to divide a luggage compartment vertically. Since there are respective spaces above and below the deck board, users can store luggage both above and below the deck board. When users do not use the deck board, they can store taller luggage in the luggage compartment.

Japanese Unexamined Patent Application Publication No. 2009-255612 discloses a deck board movement mechanism configured to be movable vertically between an upper position and a lower position by forming a circumferential groove in a side wall of an under tray.

### BRIEF SUMMARY OF THE INVENTION

Unfortunately, to configure the above-described deck board movement mechanism, it is necessary to form the circumferential groove in the side wall of the under tray.

The present invention discloses a vehicle deck board that can be quickly switched from a non-use state to a use state, and a leg member thereof.

One aspect of the present invention provides a vehicle deck board to be disposed in a luggage compartment of a vehicle, the vehicle deck board comprising:
a deck board body having a placement surface for luggage, the deck board body having a back surface opposite to the placement surface;
a leg body having a base end part rotatably connected to the deck board body around a rotation axis along the back surface, the leg body having a tip end part on a side opposite to the base end part, the leg body being rotatable between a storage position along the back surface and an upright position erected from the back surface; and
a floor lock mechanism located at the tip end part of the leg body, the floor lock mechanism being configured to releasably lock the leg body to the floor when the leg body at the upright position is placed on a floor of the luggage compartment.

Another aspect of the present invention provides a vehicle deck board to be disposed in a luggage compartment of a vehicle, the vehicle deck board comprising:
a deck board body having a placement surface for luggage, the deck board body having a back surface opposite to the placement surface;
a leg body rotatably connected to the deck board body around a rotation axis along the back surface, the leg body being rotatable between a storage position along the back surface and an upright position erected from the back surface;
a first energizing portion applying a rotatable first force to the leg body from the storage position to the upright position;
a storage lock mechanism configured to releasably lock the leg body at the storage position; and
a raising operation portion releasing the lock of the leg body by the storage lock mechanism when the raising operation portion is operated.

Another aspect of the present invention provides a leg member for a vehicle deck board, the leg member including a deck board body having a placement surface for luggage, the deck board body having a back surface opposite to the placement surface, the leg member comprising:
a leg body having a base end part to be rotatably connected to the deck board body around a rotation axis along the back surface, the leg body having a tip end part on a side opposite to the base end part, the leg body being configured to be rotatable between a storage position along the back surface and an upright position erected from the back surface; and
a floor lock mechanism located at the tip end part of the leg body, the floor lock mechanism being configured to releasably lock the leg body to the floor when the leg body at the upright position is placed on a floor of a luggage compartment.

Another aspect of the present invention provides a leg member for a vehicle deck board, the leg member including a deck board body having a placement surface for luggage, the deck board body having a back surface opposite to the placement surface, the leg member comprising:
a leg body to be rotatably connected to the deck board body around a rotation axis along the back surface, the leg body being configured to be rotatable between a storage position along the back surface and an upright position erected from the back surface;
a first energizing portion configured to apply a rotatable first force to the leg body from the storage position to the upright position;
a storage lock mechanism configured to releasably lock the leg body at the storage position; and
a raising operation portion configured to release the lock of the leg body by the storage lock mechanism when the raising operation portion is operated.

These and other features, aspects, and advantages of the invention will be apparent to those skilled in the art from the following detailed description of preferred non-limiting exemplary embodiments together with the drawings and the claims.

### BRIEF DESCRIPTION OF THE DRAWINGS

FIG. 1 is a schematic view showing an example of a vehicle equipped with a vehicle deck board.

FIG. 2 is a schematic side view showing an example of the vehicle deck board in a state where a rear board body is at a non-use position P5.

FIG. 3A is a schematic view showing an example of the vehicle equipped with the vehicle deck board in a state where the rear board body is at a non-use position P4.

FIG. 3B is a schematic view showing an example of the vehicle equipped with the vehicle deck board in a state where the rear board body is at a use position P3.

FIG. 4 is a schematic perspective view showing an example of the vehicle deck board in a state where a leg body is at an upright position P2.

FIG. 5 is a schematic rear view showing an example of the vehicle deck board in a state where the leg body at the upright position P2 is locked to a floor of a luggage compartment.

FIG. 6 is a schematic view showing an example of a floor lock mechanism and a floor lock release operation portion.

FIG. 7 is a schematic perspective view showing an example of the floor lock mechanism.

FIG. 8A is a schematic view showing an example of the leg body separated from the floor of the luggage compartment.

FIG. 8B is a schematic view showing an example of the leg body being inserted into a recess of a floor board.

FIG. 8C is a schematic view showing an example of the leg body locked to the floor of the luggage compartment.

FIG. 9 is a schematic perspective view showing an example of a tip end part of the leg body.

FIG. 10 is a schematic perspective view showing an example of a storage lock mechanism and a raising operation portion.

FIG. 11A is a schematic view showing an example of the storage lock mechanism and the raising operation portion in a state where they are separated from the tip end part of the leg body.

FIG. 11B is a schematic view showing an example of the storage lock mechanism and the raising operation portion in a state where a first claw part is pushed by the tip end part of the leg body.

FIG. 11C is a schematic view showing an example of the storage lock mechanism and the raising operation portion in a state where the first claw part has engaged the tip end part of the leg body.

### DETAILED DESCRIPTION OF THE INVENTION

Some embodiments of the present invention will be described below. Of course, the following embodiments merely exemplify the present invention, and not all features shown in the embodiments are necessarily essential to the solution.

### (1) Overviews of the Present Disclosure

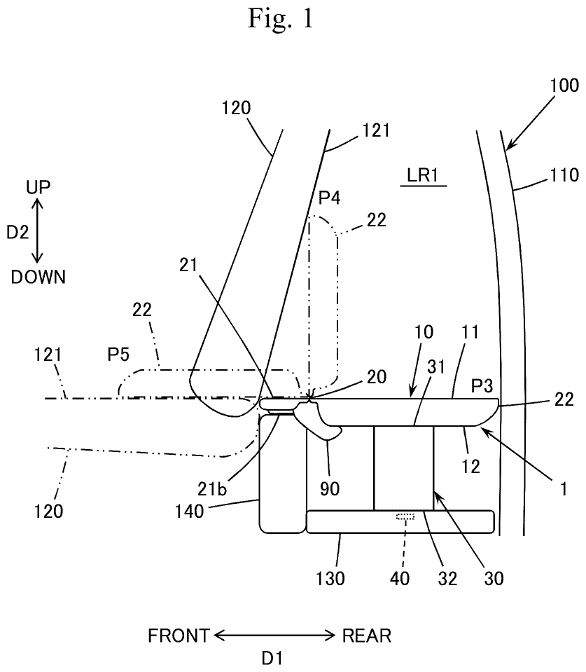

First, overviews of the present disclosure are given referring to examples shown in FIGS. 1 to 11C. The figures in the present application are schematic illustrations of examples, magnification ratio in each direction shown in these figures may differ, and the figures may not be consistent with each other. Of course, each element of the present disclosure is not limited to the specific examples indicated by reference signs. In “Overviews of the present disclosure”, parentheses refer to supplementary explanations of the immediately preceding words.

In the present application, the numerical range “Min to Max” refers to the minimum value Min or more and the maximum value Max or less.

### Embodiment 1

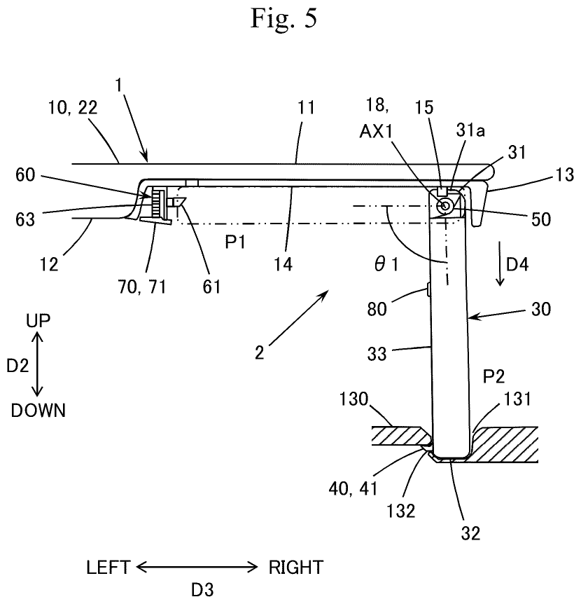

A vehicle deck board 1 according to one embodiment is, as illustrated in FIGS. 1, 5, etc., a vehicle deck board 1 to be disposed in a luggage room or luggage compartment LR1 of a vehicle (for example, automobile 100), comprising a deck board body 10, a leg body 30, and a floor lock mechanism 40. The deck board body 10 has a placement surface 11 for luggage, and a back surface 12 opposite to the placement surface 11. The leg body 30 has a base end part 31 rotatably connected to the deck board body 10 around a rotation axis AX1 along the back surface 12. The leg body 30 has a tip end part 32 on a side opposite to the base end part 31. The leg body 30 is rotatable between a storage position P1 along the back surface 12 and an upright position P2 erected from the back surface 12. The floor lock mechanism 40 is located at the tip end part 32 of the leg body 30. The floor lock mechanism 40 is configured to releasably locks the leg body 30 to the floor (130) when the leg body 30 at the upright position P2 is placed on a floor (for example, floor board 130) of the luggage compartment LR1.

It should be noted that “rotation” refers to a movement of rotating in both forward and reverse directions. Hereinafter, the vehicle deck board may be simply referred to as deck board 1.

In the above embodiment, the leg body 30, which is rotatable between the storage position P1 and the upright position P2, is releasably locked to the floor (130) of the luggage compartment LR1 by the floor lock mechanism 40 when the leg body 30 is placed on the floor (130) at the upright position P2. This brings the deck board 1 into a use state. The above embodiment, therefore, can provide the vehicle deck board that can be quickly switched from a non-use state to the use state.

Various examples can be given for the above-described embodiment.

The base end part of the leg body refers to a part having volume in the leg body. The tip end part of the leg body also refers to a part having volume in the leg body. Thus, the floor lock mechanism may be a mechanism configured to lock the leg body to the floor of the luggage compartment by a member that can advance laterally from the tip end part of the leg body at the upright position, may be a mechanism configured to lock the leg body to the floor of the luggage compartment by a member that can advance downward from the tip end part of the leg body at the upright position, or may be another mechanism.

Of course, the above additional remarks also apply to the following embodiments.

### Embodiment 2

As illustrated in FIG. 5, etc., the present vehicle deck board 1 may further comprise a first energizing portion (for example, first energizing member or spring 50) that applies a rotatable first force to the leg body 30 from the storage position P1 to the upright position P2. The vehicle deck board 1 may further comprise a storage lock mechanism 60 configured to releasably lock the leg body 30 at the storage position P1. The vehicle deck board 1 may further comprise a raising operation portion (for example, push switch portion 71) that releases the lock of the leg body 30 by the storage lock mechanism 60 when the raising operation portion is operated.

In the above case, the leg body 30 is releasably locked by the storage lock mechanism 60 at the storage position P1. When the user operates the raising operation portion (71), the lock of the leg body 30 by the storage lock mechanism 60 is released, and the leg body 30, to which the rotatable first force from the storage position P1 to the upright position P2 is applied by the first energizing portion (50), rotates from the storage position P1 to the upright position P2. Since the leg body 30 switches from a storage state to an upright state by operating the raising operation portion (71), the deck board 1 quickly switches from the non-use state to the use state. Thus, the above embodiment can provide the vehicle deck board that can be switched even more quickly from the non-use state to the use state.

Herein, the raising operation portion may release the lock of the leg body by the storage lock mechanism by push operation of a push button that can be operated by pushing, or may release the lock of the leg body by the storage lock mechanism by operation of a slide switch that can be operated by sliding or the like.

In the present application, the terms “first”, “second”, . . . are used to identify each component included in multiple components having similarities, and may not refer to order. The above additional remarks also apply to the following embodiments.

### Embodiment 3

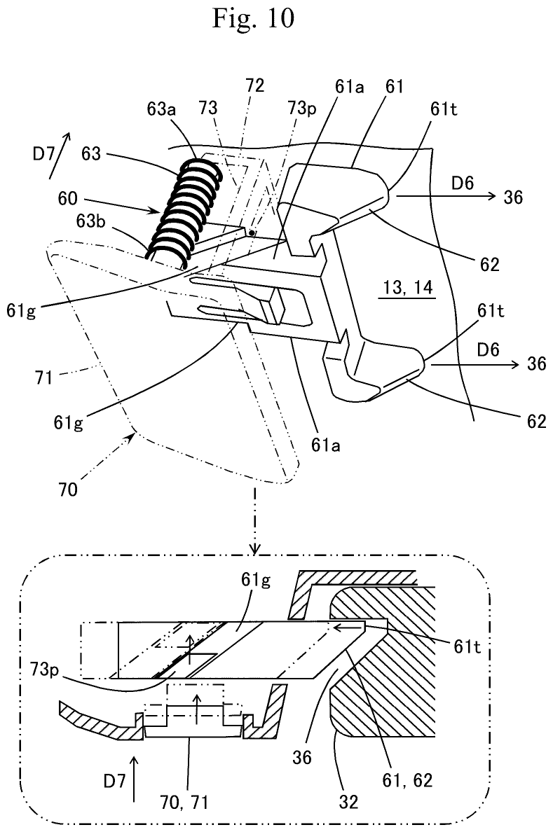

As illustrated in FIGS. 5, 10, etc., the storage lock mechanism 60 may include a first claw part (for example, first claw member 61) configured to catch on the leg body 30 when advanced and allows rotation of the leg body 30 when retracted. The storage lock mechanism 60 may include a second energizing portion (for example, spring 63) that applies a second force to advance the first claw part (61). When the raising operation portion (71) is operated, the first claw part (61) may retract against the second force by the second energizing portion (63). When the operation of the raising operation portion (71) is released, the first claw part (61) may advance by the second force applied by the second energizing portion (63). The first claw part (61) may have a shape (for example, inclined part 62) that causes the first claw part (61) to retract and then advance by the second force applied by the second energizing portion (63) when the leg body 30 rotates from the upright position P2 to the storage position P1.

In the above case, when the leg body 30 is at the storage position P1 and the user operates the raising operation portion (71), the first claw part (61) retracts against the second force by the second energizing portion (63), and the leg body 30, to which the rotatable first force from the storage position P1 to the upright position P2 is applied by the first energizing portion (50), rotates from the storage position P1 to the upright position P2. When the user rotates the leg body 30 from the upright position P2 to the storage position P1, the first claw part (61) retracts and then advances by the second force applied by the second energizing portion (63), and the leg body 30 is locked at the storage position P1 by the storage lock mechanism 60. Thus, the above embodiment can provide the vehicle deck board that can be quickly switched from the use state to the non-use state as well.

Herein, the second energizing portion may apply the second force to advance the first claw part through the raising operation portion. This additional remark also applies to the following embodiments.

### Embodiment 4

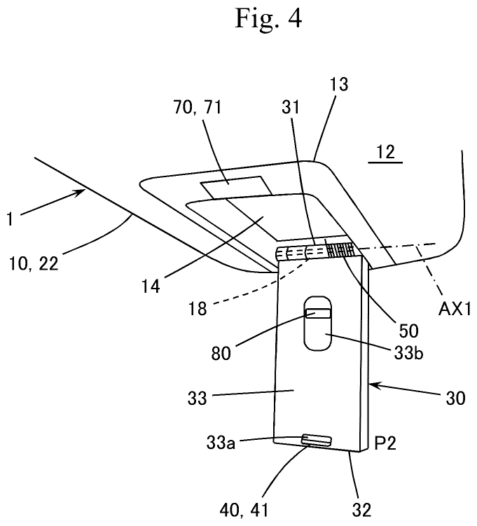

As illustrated in FIG. 4, etc., the leg body 30 may have a storage surface 33 that faces the back surface 12 of the deck board body 10 when the leg body 30 is at the storage position P1. The present vehicle deck board 1 may further comprise a floor lock release operation portion (for example, floor lock release operation member 80) located on the storage surface 33. The floor lock release operation portion may release the lock of the leg body 30 by the floor lock mechanism 40 when the floor lock release operation portion is operated.

When the floor lock mechanism 40 is locking the leg body 30 at the upright position P2 to the floor (130) of the luggage compartment LR1, the floor lock release operation portion (80), which is located on the storage surface 33 of the leg body 30, is exposed. Herein, when the user operates the floor lock release operation portion (80), the lock of the leg body 30 by the floor lock mechanism 40 is released, and the user can separate the leg body 30 from the floor (130) and rotate the leg body 30 from the floor (130) to the storage position P1. When the leg body 30 reaches the storage position P1, the leg body 30 is locked at the storage position P1 by the storage lock mechanism 60. Thus, the above embodiment can quickly switch the vehicle deck board 1 from the use state to the non-use state as well. Furthermore, when the leg body 30 is at the storage position P1, since the storage surface 33 of the leg body 30 faces the back surface 12 of the deck board body 10, the floor lock release operation portion (80) is hidden. This causes the appearance of the back surface of the vehicle deck board to be good.

### Embodiment 5

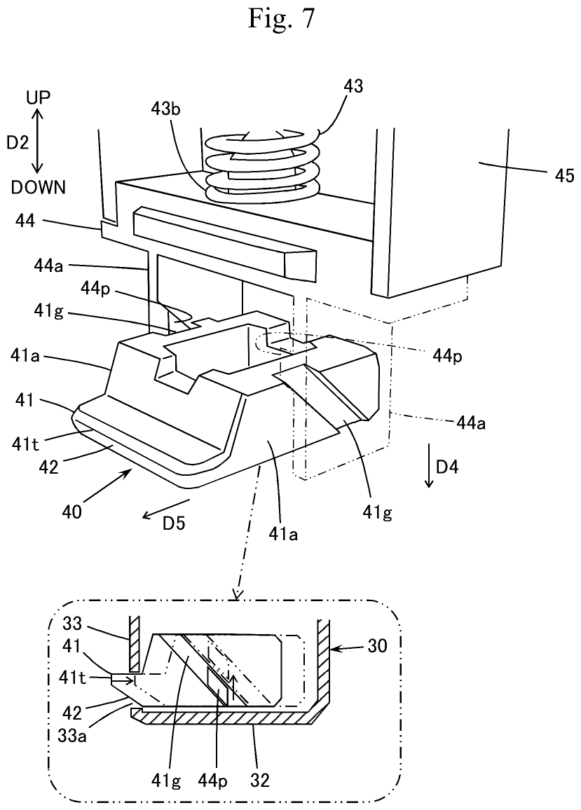

As illustrated in FIG. 7, etc., the floor lock mechanism 40 may include a second claw part (for example, second claw member 41) configured to catch on the floor (130) when advanced and release the leg body 30 from the floor (130) when retracted. The floor lock mechanism 40 may include a third energizing portion (for example, spring 43) that applies a third force to advance the second claw part (41). When the floor lock release operation portion (80) is operated, the second claw part (41) may retract against the third force by the third energizing portion (43). When the operation of the floor lock release operation portion (80) is released, the second claw part (41) may advance by the third force applied by the third energizing portion (43). The second claw part (41) may have a shape (for example, inclined part 42) that causes the second claw part (41) to retract and then advance by the third force applied by the third energizing portion (43) when the leg body 30 at the upright position P2 is placed on the floor (130).

In the above case, when the leg body 30 at the upright position P2 is locked to the floor (130) and the user operates the floor lock release operation portion (80), the second claw part (41) retracts against the third force by the third energizing portion (43), and the user can separate the leg body 30 from the floor (130) and rotate the leg body 30 to the storage position P1. When the user places the leg body 30 at the upright position P2 on the floor (130), the second claw part (41) retracts and then advances by the third force applied by the third energizing portion (43), and the leg body 30 is locked to the floor (130) by the floor lock mechanism 40. Thus, the above embodiment can provide the vehicle deck board that can quickly switch between the use state and the non-use state.

### Embodiment 6

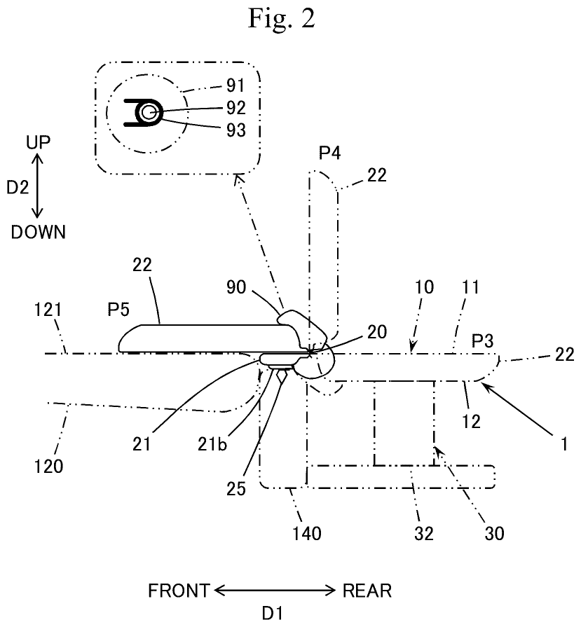

As illustrated in FIGS. 1, 2, etc., the deck board body 10 may include a rear board body 22 that the leg body 30 is connected to, a front board body 21 that is in front of the rear board body 22, and a hinge portion 20. The rear board body 22 and the front board body 21 may be connected via the hinge portion 20 to be capable of bending operation. The front board body 21 may be configured to be fixed to the vehicle (100) in the luggage compartment LR1. The present vehicle deck board 1 may be disposed at a use position P3 where the back surface 12 of the rear board body 22 faces downward. The vehicle deck board 1 further comprise a fourth energizing portion 90 that applies a fourth force in a direction to rotate the rear board body 22 upward from the use position P3, with the hinge portion 20 as a base point.

In the above case, when the rear board body 22 rotates upward with the hinge portion 20 as the base point, the fourth force in the direction of the rotation is applied to the rear board body 22. This prevents the rear board body 22 from returning to the use position P3. Thus, the above embodiment can provide a suitable example for maintaining the non-use state of the rear board body by rotating the rear board body upward with the hinge portion as the base point.

### Embodiment 7

A vehicle deck board 1 according to another embodiment comprises, as illustrated in FIGS. 1, 5, etc., a deck board body 10, a leg body 30, a first energizing portion (50), a storage lock mechanism 60, and a raising operation portion (71). The deck board body 10 has a placement surface 11 for luggage, and a back surface 12 opposite to the placement surface 11. The leg body 30 is rotatably connected to the deck board body 10 around a rotation axis AX1 along the back surface 12, and is rotatable between a storage position P1 along the back surface 12 and an upright position P2 erected from the back surface 12. The first energizing portion (50) applies a rotatable first force to the leg body 30 from the storage position P1 to the upright position P2. The storage lock mechanism 60 is configured to releasably lock the leg body 30 at the storage position P1. The raising operation portion (71) releases the lock of the leg body 30 by the storage lock mechanism 60 when the raising operation portion (71) is operated.

In the above case, the leg body 30 is releasably locked by the storage lock mechanism 60 at the storage position P1. Herein, when the user operates the raising operation portion (71), the lock of the leg body 30 by the storage lock mechanism 60 is released, and the leg body 30, to which the rotatable first force from the storage position P1 to the upright position P2 is applied by the first energizing portion (50), rotates from the storage position P1 to the upright position P2. Since the leg body 30 switches from a storage state to an upright state by operating the raising operation portion (71), the deck board 1 quickly switches from a non-use state to a use state. Thus, the above embodiment can provide the vehicle deck board that can be quickly switched from the non-use state to the use state.

### Embodiment 8

Incidentally, an embodiment of the leg member attached to the deck board body 10 is also conceivable.

The leg member 2 of the vehicle deck board 1 according to one embodiment comprises the above leg body 30 and the above floor lock mechanism 40. The present embodiment can provide the leg member for the vehicle deck board that can be quickly switched from the non-use state to the use state.

### Embodiment 9

The leg member 2 of the vehicle deck board 1 according to another embodiment comprises the above leg body 30, the above first energizing portion (50), the above storage lock mechanism 60, and the above raising operation portion (71). The present embodiment can provide the leg member for the vehicle deck board that can be quickly switched from the non-use state to the use state.

### (2) Specific Example of Vehicle Deck Board

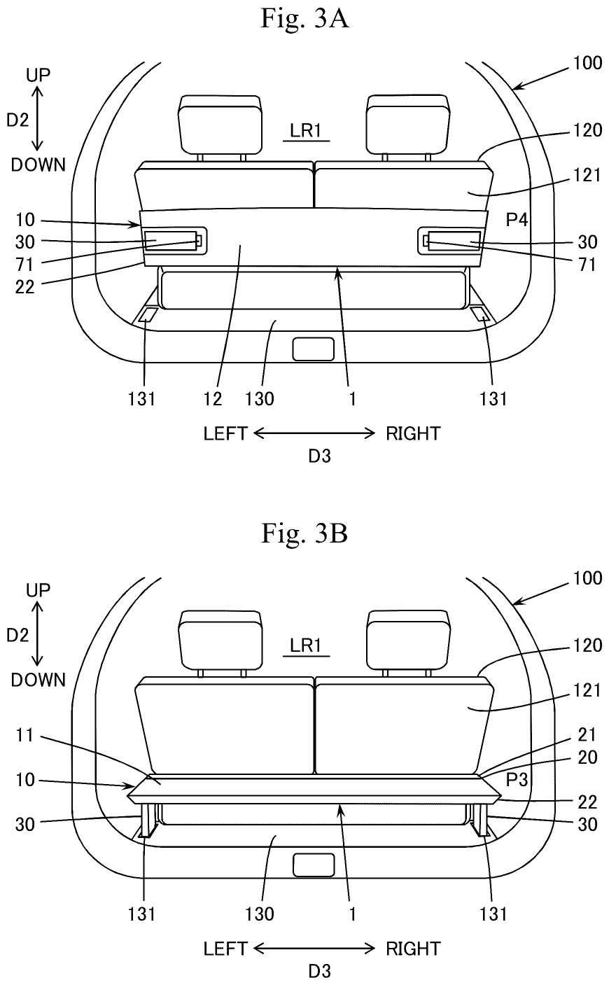

FIG. 1 schematically illustrates the automobile 100 as the vehicle equipped with the vehicle deck board 1. FIG. 1 shows, with two-dot chain lines, a state where a seat 120 immediately in front of the luggage compartment LR1 is folded forward, and the rear board body 22 at non-use positions P4 and P5. FIG. 2 schematically illustrates the deck board 1 in a state where the rear board body 22 is at the non-use position P5. An example of the fourth energizing portion 90 is schematically shown in the upper part of FIG. 2. FIG. 3A schematically illustrates the automobile 100 equipped with the deck board 1 in a state where the rear board body 22 is at the non-use position P4. FIG. 3B schematically illustrates the automobile 100 equipped with the deck board 1 in a state where the rear board body 22 is at the use position P3. FIG. 4 schematically illustrates the deck board 1 in a state where the leg body 30 of the deck board 1 is at the upright position P2. FIG. 5 schematically illustrates the deck board 1 in a state where the leg body 30 at the upright position P2 is locked to the floor board 130 as the floor of the luggage compartment LR1. In these figures, FRONT, REAR, LEFT, RIGHT, UP, and DOWN indicate front, rear, left, right, up, and down, respectively. The left-right positional relationship is based on the direction of looking forward while sitting in the driver's seat of the automobile 100. In addition, the reference sign D1 indicates the front-rear direction of the automobile 100, the reference sign D2 indicates the up-down direction of the automobile 100, and the reference sign D3 indicates the vehicle width direction of the automobile 100. The front-rear direction D1, up-down direction D2, and vehicle width direction D3 are orthogonal to each other, but even if they are not orthogonal due to design or other factors, they are included in the embodiments of the present application as long as they intersect with each other. It should be noted that “orthogonal” is not limited to exactly 90°, but includes deviation from exactly 90° due to error. Identity of direction, position, etc. is not limited to exact matching, but includes deviation from exact matching due to error. Furthermore, the description of the positional relationship of each part is merely an example.

The automobile 100 shown in FIG. 1 is a road vehicle designed and equipped for use on roads, and for example, vehicle body panels made of metal panels such as steel plates surround a cabin including the luggage compartment LR1 to form a vehicle body. The automobile 100 is equipped with a tailgate 110 behind the luggage compartment LR1, a seat 120 immediately in front of the luggage compartment LR1 in an upright state where passengers can be seated, the floor board 130 defining the floor surface of the luggage compartment LR1, a tool box 140 fixed to the vehicle body in front of the floor board 130, and the like. The tailgate 110 has an upper edge when closed. The tailgate 110 is attached to a vehicle body panel such as a ceiling panel so that the tailgate 110 can be opened outward with the upper edge as the rotation center. When the tailgate 110 is open, the rear of the automobile 100 opens as shown in FIGS. 3A and 3B, and users can access the luggage compartment LR1. The seat 120 can adjust the reclining angle, and can also be folded forward so that the back surface 121 can be substantially horizontal. When the seat 120 is folded forward, it is possible to place large luggage from the back surface 121 of the seat 120 to the placement surface 11 of the deck board body 10. The seat 120 may be a rear seat in a two-row seat configuration, may be a third seat in a three-row seat configuration, or may be another seat. The back surface 121 of the seat 120 in the upright state defines the front surface of the luggage compartment LR1. The floor board 130 has, as shown in FIG. 5, a recess 131 on the upper surface of the floor board 130. The recess 131 is connected to an engagement hole 132 configured to catch the second claw member 41 of the leg body 30. The tool box 140 can store triangular warning signs and various tools.

The deck board 1 is disposed in the luggage compartment LR1 of the automobile 100. The deck board 1 shown in FIGS. 1 to 5 comprises the deck board body 10, the leg body 30, the floor lock mechanism 40, the spring 50 as the first energizing portion, the storage lock mechanism 60, the raising operation member 70, the floor lock release operation member 80 as the floor lock release operation portion, the fourth energizing portion 90, and the like. The leg member 2 (refer to FIG. 5) according to the present specific example comprises a bezel 13, a shaft 18, the leg body 30, the floor lock mechanism 40, the spring 50, the storage lock mechanism 60, the raising operation member 70, and the floor lock release operation member 80. The leg member 2 is attached to the deck board body 10. The deck board 1 comprises a plurality of the leg bodies 30. The respective leg bodies 30 are rotatably connected to the rear board body 22 of the deck board body 10 near both ends in the vehicle width direction D3. In other words, the deck board 1 comprises a pair of leg bodies 30. Thus, the deck board 1 comprises a pair of floor lock mechanisms 40, a pair of springs 50, a pair of storage lock mechanisms 60, a pair of raising operation members 70, and a pair of floor lock release operation members 80. The deck board 1 further comprises a plurality of the fourth energizing portions 90. The respective fourth energizing portions 90 are attached to both ends of the front board body 21 of the deck board body 10 in the vehicle width direction D3. In other words, the deck board 1 comprises a pair of fourth energizing portions 90.

It should be noted that the material of the deck board 1 is not particularly limited. For example, the main part of the deck board 1 may be formed from a material mainly composed of synthetic resin such as thermoplastic resin. The springs included in the deck board 1 may be made of metal.

The deck board body 10 includes the front board body 21 disposed on the tool box 140, the rear board body 22 behind the front board body 21, and the hinge portion 20 between the front board body 21 and the rear board body 22. As shown in FIG. 2, the front board body 21 is fixed to the upper surface of the tool box 140 by clips 25 (for example, resin clips) attached to the back surface 21b of the front board body 21. Thus, the front board body 21 is configured to be fixed to the automobile 100 in the luggage compartment LR1. The front board body 21 and the rear board body 22 are connected via the hinge portion 20 to be capable of bending operation. When the rear board body 22 is at the use position P3 separated upward from the floor board 130, the placement surface 11 where luggage can be placed faces upward, and the back surface 12 faces downward. In other words, the deck board body 10 has the placement surface 11 for luggage, and the back surface 12 opposite to the placement surface 11. The leg body 30 is connected to the rear board body 22 on the back surface 12. The hinge portion 20 is, for example, a thinned portion in the deck board body 10 mainly composed of resin. The hinge portion 20 is a longitudinal portion along the rotation axis that can be the rotation center of the rear board body 22. The deck board body 10, which includes the hinge portion 20, can be formed by performing thermoforming such as hot stamp forming or injection molding so that thin-walled portions can be formed of a material mainly composed of thermoplastic resin.

As shown in FIGS. 1 and 2, the fourth energizing portion 90 in contact with the back surface of the rear board body 22 is attached to the back surface 21b of the front board body 21. The fourth energizing portion 90 includes a cover 91 in contact with the back surface of the rear board body 22, a shaft 92 along the rotation axis that can be the rotation center of the cover 91, a spring 93 disposed around the shaft 92, and the like. The spring 93 should be able to apply the fourth force in the direction to rotate the rear board body 22 upward from the use position P3 with the hinge portion 20 as the base point. The spring 93 may be a helical torsion spring (torsion spring) as shown in FIG. 2, or may be a spiral spring or the like. The fourth energizing portion 90 including the spring 93 applies the force in the direction to rotate the rear board body 22 upward from the use position P3 with the hinge portion 20 as the base point. When the seat 120 is in the upright state as shown in FIG. 1, the rear board body 22 is held at the non-use position P4 against the back surface 121 of the seat 120 by the force applied from the fourth energizing portion 90. In other words, the rear board body 22 at the non-use position P4 continues to contact the back surface 121 of the seat 120. When the seat 120 is folded forward, the rear board body 22 is held at a non-use position P5 placed on the back surface 121 of the seat 120. The rear board body 22 at the non-use position P5 is placed on the back surface 121 of the seat 120 by its own weight. Alternatively, the fourth energizing portion 90 may apply the force pressing against the back surface 121 to the rear board body 22 at the non-use position P5. The rear board body 22 at the use position P3 may rotate to the non-use position P4 or the non-use position P5 by the force applied from the fourth energizing portion 90, or may remain at the use position P3 by its own weight.

The rear board body 22 at the non-use position P4 or the non-use position P5 is prevented from returning to the use position P3 by the force applied from the fourth energizing portion 90. This causes the non-use state of the rear board body 22 to be maintained with a simple structure.

As shown in FIGS. 4 and 5, respective bezels 13 are provided near the left and right edges on the back surface 12 of the rear board body 22. Each of the bezels 13 has a recess 14 recessed from the surroundings on the back surface 12. A positioning protrusion 15 for positioning the leg body 30 in the upright state is formed in each of the recesses 14. A shaft 18 along the rotation axis AX1 of the rotatable leg body 30 is attached to each of the bezels 13 within the recess 14. Each of the shafts 18 is along the back surface 12.

Each of the leg bodies 30 has the base end part 31 rotatably connected to the rear board body 22 around the rotation axis AX1 along the back surface 12. Each of the leg bodies 30 has the tip end part 32 on the side opposite to the base end part 31. It should be noted that the direction from the base end part 31 toward the tip end part 32 is referred to as an extension direction D4 of the leg body 30. The base end part 31 has a positioning part 31a for positioning the leg body 30 in the upright state. The leg body 30 is rotatable between the storage position P1 where the body 30 is stored in the recess 14 and the upright position P2 erected from the back surface 12. In other words, the storage position P1 is a position where the leg body 30 is along the back surface 12 of the rear board body 22. The leg body 30 has the storage surface 33 that faces the back surface 12 of the rear board body 22 when the leg body 30 is at the storage position P1. The floor lock release operation member 80 and the like are disposed on the storage surface 33. When the leg body 30 rotates from the storage position P1 to the upright position P2, the positioning part 31a of the base end part 31 abuts against the positioning protrusion 15 of the bezel 13. This keeps the leg body 30 at the upright position P2. Thus, the positioning protrusion 15 and the positioning part 31a constitute a positioning structure that keeps the leg body 30 at the upright position P2.

The angle θ1 formed between the leg body 30 at the storage position P1 and the leg body 30 at the upright position P2 may be, for example, 85 to 100°, and may be 90 to 95°, particularly an angle slightly wider than 90°, from the point of improving the stability of supporting the deck board body 10. The leg body 30 at the upright position P2 supports the rear board body 22 at the use position P3 separated from the floor board 130.

Around the shaft 18, the spring 50 as the first energizing portion that applies the rotatable first force to the leg body 30 from the storage position P1 to the upright position P2 is provided. The spring 50 may be the helical torsion spring as shown in FIGS. 4 and 5, or may be a spiral spring or the like. When the lock of the leg body 30 at the storage position P1 is released, the spring 50 rotates the leg body 30 from the storage position P1 to the upright position P2 by applying the aforementioned force to the leg body 30. In addition, a damper that limits the rotation speed of the leg body 30 may be provided around the shaft 18.

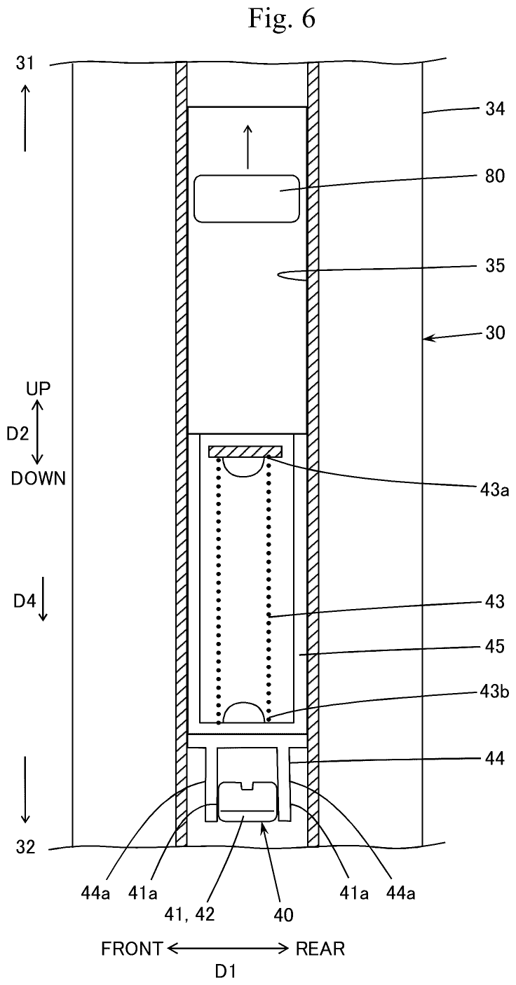

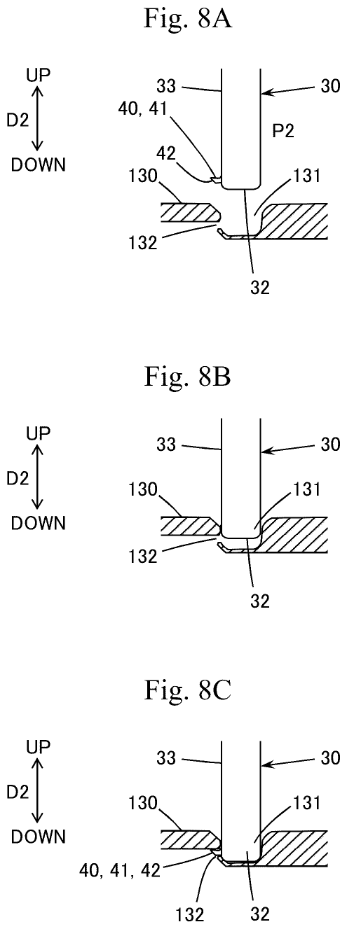

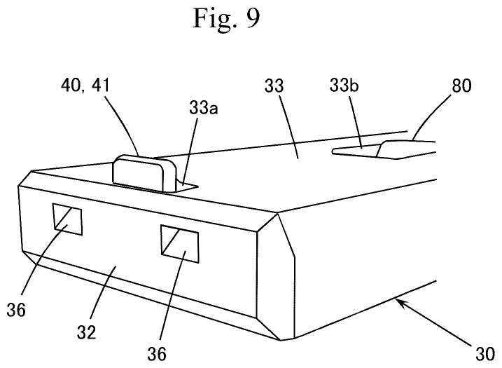

FIG. 6 schematically illustrates the floor lock mechanism 40 and the floor lock release operation member 80 in a cross-sectional view of the case 34 of the leg body 30. FIG. 7 schematically illustrates the external appearance of the floor lock mechanism 40 with a part of the interlocking member 44 shown transparently. The lower part of FIG. 7 schematically shows an example of the movement of the second claw member 41 as the second claw part. FIG. 8A schematically illustrates an example of the leg body 30 separated from the floor board 130. FIG. 8B schematically illustrates an example of the leg body 30 being inserted into the recess 131 of the floor board 130. FIG. 8C schematically illustrates an example of the leg body 30 locked to the floor board 130. FIG. 9 schematically illustrates the external appearance of the tip end part 32 of the leg body 30.

The floor lock mechanism 40 includes the second claw member 41, the spring 43 as the third energizing portion, and an interlocking member 44 slidably engaged with the second claw member 41. The floor lock mechanism 40 is provided at the tip end part 32 of the leg body 30. The storage surface 33 of the tip end part 32 has an opening 33a for advancing the tip end part 41t of the second claw member 41. The part of the tip end part 41t facing toward the tip end part 32 of the leg body 30 is the tapered inclined part 42. In other words, the inclined part 42 is an inclined surface that is farther from the tip end part 32 of the leg body 30 the closer it is to the tip of the second claw member 41. When the leg body 30 at the upright position P2 is oriented in the up-down direction D2 as shown in FIGS. 5 to 7, the inclined part 42 is the inclined surface that is higher the closer it is to tip of the second claw member 41. In contrast, the part of the tip end part 41t facing toward the base end part 31 of the leg body 30 is a surface along the advancing direction D5 of the tip end part 41t. The advancing direction D5 is generally a direction orthogonal to the extension direction D4 of the leg body 30.

From the above, the second claw member 41 catches on the floor board 130 when advanced, and releases the leg body 30 from the floor board 130 when retracted.

Both side surfaces 41a of the second claw member 41 have inclined grooves 41g that are farther from the tip end part 32 of the leg body 30 the closer they are to the tip of the second claw member 41. When the leg body 30 at the upright position P2 is placed on the floor board 130, the grooves 41g are inclined grooves that are higher the closer they are to tip of the second claw member 41.

The spring 43 shown in FIGS. 6 and 7 is a compression coil spring with a fixed end 43a engaged with the case 34 and a movable end 43b engaged with the interlocking member 44. The spring 43 applies a force to the interlocking member 44 in a direction that brings the interlocking member 44 closer to the tip end part 32 of the leg body 30. When the leg body 30 at the upright position P2 is oriented in the up-down direction D2 as shown in FIGS. 5 to 7, the upper end of the spring 43 is the fixed end 43a, the lower end of the spring 43 is the movable end 43b, and the spring 43 applies a downward force to the interlocking member 44. By transmitting the force from the spring 43 to the second claw member 41 via the interlocking member 44, the spring 43 applies the third force to advance the second claw member 41. Of course, the spring 43 is not limited to the compression coil spring.

The interlocking member 44 includes respective extension parts 44a facing both side surfaces 41a of the second claw member 41. Each of the extension parts 44a includes a protrusion 44p that can slide within the groove 41g. The groove 41g of the second claw member 41 and the protrusion 44p of the interlocking member 44 constitute a first movement direction conversion mechanism that changes movements between a movement along the extension direction D4 and a movement along the advancing direction D5. Thereby, when the interlocking member 44 moves away from the tip end part 32 of the leg body 30, the tip end part 41t of the second claw member 41 retracts into the leg body 30, and when the interlocking member 44 approaches the tip end part 32 of the leg body 30, the tip end part 41t of the second claw member 41 advances from the opening 33a. When the tip end part 41t retracts into the leg body 30, the interlocking member 44 moves away from the tip end part 32 of the leg body 30, and when the tip end part 41t advances from the opening 33a, the interlocking member 44 approaches the tip end part 32 of the leg body 30.

As shown in FIGS. 8A to 8C, when the tip end part 32 of the leg body 30 at the upright position P2 is inserted into the recess 131 of the floor board 130, first, the inclined part 42 contacts the floor board 130. This causes the tip end part 41t of the second claw member 41 to retract into the leg body 30 against the force by the spring 43. The changes in the leg body 30 and the floor lock mechanism 40 at this time are shown in FIGS. 8A and 8B. When the tip end part 41t of the second claw member 41 gets over the floor board 130, the tip end part 41t advances from the opening 33a by the force applied by the spring 43, and enters the engagement hole 132 of the floor board 130, as shown in FIG. 8C. Thus, the inclined portion 42 has the shape that causes the second claw member to retract and then advance by the third force applied by the spring 43 when the leg body 30 at the upright position P2 is placed on the floor board 130.

From the above operation, when the leg body 30 at the upright position P2 is placed on the floor board 130, the floor lock mechanism 40 releasably locks the leg body 30 to the floor board 130.

The storage surface 33 of the leg body 30 has an opening 33b for allowing the slide operation of the floor lock release operation member 80 that releases the lock of the leg body 30 by the floor lock mechanism 40 through operation. The floor lock release operation member 80 appears in the opening 33b, and is connected to the interlocking member 44 via a transmission member 45. As shown in FIG. 6, one end of the transmission member 45 is attached to the floor lock release operation member 80, and the other end of the transmission member 45 is attached to the interlocking member 44. The case 34 of the leg body 30 has a groove 35 along the extension direction D4. The floor lock release operation member 80, the transmission member 45, and the interlocking member 44 can slide along the groove 35 within a predetermined range.

When the floor lock release operation member 80 is not being operated, the spring 43 applies the force in the extension direction D4 to the interlocking member 44. This force is converted to the force in the advancing direction D5 that is applied to the second claw member 41 by the first movement direction conversion mechanism (41g and 44p) between the interlocking member 44 and the second claw member 41. As a result, the tip end part 41t of the second claw member 41 is protruding from the opening 33a, and the floor lock release operation member 80, the transmission member 45, and the interlocking member 44 are at the position closest to the tip end part 32 of the leg body 30.

When the user slides the floor lock release operation member 80 toward the base end part 31 with his or her finger, the interlocking member 44 moves toward the base end part 31 via the transmission member 46, and the tip end part 41t of the second claw member 41 retracts into the leg body 30 via the first movement direction conversion mechanism (41g and 44p). In this way, when the floor lock release operation member 80 is slid, the second claw member 41 retracts against the force by the spring 43, and the lock of the leg body 30 by the floor lock mechanism 40 is released. As a result, the user can separate the leg body 30 from the floor board 130 and rotate the leg body 30 to the storage position P1.

When the user releases his or her finger from the floor lock release operation member 80, the interlocking member 44 moves in the extension direction D4 by the force applied by the spring 43, and the second claw member 41 moves in the advancing direction D5 via the first movement direction conversion mechanism (41g and 44p). Thereby, the tip end part 41t of the second claw member 41 advances from the opening 33a. In this way, when the slide operation of the floor lock release operation member 80 is released, the second claw member 41 advances by the force applied by the spring 43.

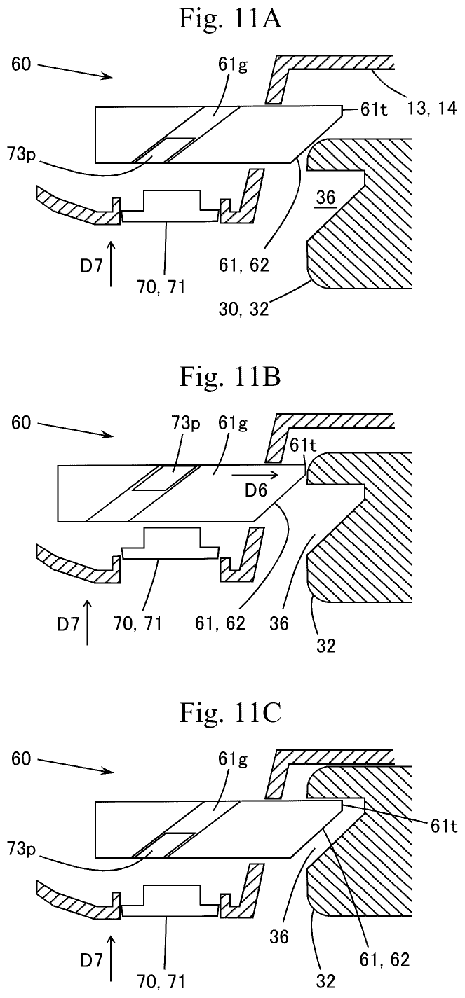

FIG. 10 schematically illustrates the external appearance of the storage lock mechanism 60 and the raising operation member 70 with the raising operation member 70 shown transparently. The lower part of FIG. 10 schematically shows an example of the movements of the first claw member 61 as the first claw part and the raising operation member 70. FIG. 11A schematically illustrates the storage lock mechanism 60 and the raising operation member 70 in a state where they are separated from the tip end part 32 of the leg body 30. FIG. 11B schematically illustrates the storage lock mechanism 60 and the raising operation member 70 in a state where the first claw member 61 is pushed by the tip end part 32 of the leg body 30. FIG. 11C schematically illustrates the storage lock mechanism 60 and the raising operation member 70 in a state where the first claw member 61 has engaged the tip end part 32 of the leg body 30.

The storage lock mechanism 60 includes the first claw member 61, the spring 63 as the second energizing portion, and a part of the raising operation member 70. The storage lock mechanism 60 is configured to releasably lock the leg body 30 at the storage position P1 via the raising operation member 70. The first claw member 61 and the spring 63 are disposed within the recess 14 of the bezel 13. The raising operation member 70 includes the push switch portion 71 as the raising operation portion, a base part 72 held by the bezel 13 so as to be slidable in a push direction D7 of the push switch portion 71, and respective connecting parts 73 facing both side surfaces 61a of the first claw member 61. The push direction D7 is a direction from the back surface 12 toward the placement surface 11 in the rear board body 22. Each of the connecting parts 73 is connected from the base part 72 to the push switch portion 71. The push switch portion 71 is also referred to as a push button. The push switch portion 71 releases the lock of the leg body 30 by the storage lock mechanism 60 through push operation.

The first claw member 61 includes a bifurcated tip end part 61t. As shown in FIG. 9, the tip end surface of the leg body 30 has respective engagement holes 36 for receiving the tip end parts 61t. The part of each tip end part 61t facing toward the push switch portion 71 is the tapered inclined part 62. Each of the inclined parts 62 is an inclined surface that is farther from the push switch portion 71 the closer it is to the tip of the first claw member 61. In contrast, the part of the tip end part 61t facing toward the bezel 13 is a surface along the advancing direction D6 of the tip end part 61t. The advancing direction D6 is generally a direction orthogonal to the push direction D7.

From the above, the first claw member 61 catches on the leg body 30 when advanced, and allows rotation of the leg body 30 when retracted.

Both side surfaces 61a of the first claw member 61 has inclined grooves 61g that are farther from the push switch portion 71 the closer they are to the tip of the first claw member 61.

The spring 63 shown in FIG. 10 is a compression coil spring with a fixed end 63a engaged with the recess 14 of the bezel 13 and a movable end 63b engaged with the push switch portion 71. The spring 63 applies a force to the push switch portion 71 in a direction opposite to the push direction D7. By transmitting the force from the spring 63 to the first claw member 61 via the raising operation member 70, the spring 63 applies the second force to advance the first claw member 61. Of course, the spring 63 is not limited to the compression coil spring.

Each of the connecting parts 73 of the raising operation member 70 includes a protrusion 73p that can slide within the groove 61g. The groove 61g of the first claw member 61 and the protrusion 73p of the connecting part 73 constitute a second movement direction conversion mechanism that changes movements between a movement along the push direction D7 and a movement along the advancing direction D6. Thereby, when the raising operation member 70 moves in the push direction D7, the tip end part 61t of the first claw member 61 retracts, and when the raising operation member 70 moves in the direction opposite to the push direction D7, the tip end part 61t of the first claw member 61 advances. The retraction of the tip end part 61t means that the tip end part 61t moves in the direction opposite to the advancing direction D6, and the advancement of the tip end part 61t means that the tip end part 61t moves in the advancing direction D6.

When push operation is not performed on the push switch portion 71, the spring 63 applies the force to the raising operation member 70 in the direction opposite to the push direction D7. This force is converted to the force in the advancing direction D6 that is applied to the first claw member 61 by the second movement direction conversion mechanism (61g and 73p) between the connecting part 73 and the first claw member 61. As a result, the tip end part 61t of the first claw member 61 is advanced, and when the leg body 30 is at the storage position P1, the tip end part 61t enters the engagement hole 36 of the leg body 30 and engages the tip end part 32 of the leg body 30.

When the user performs the push operation on the push switch portion 71 with his or her finger, the raising operation member 70 moves in the push direction D7, and the tip end parts 61t of the first claw member 61 retract from the engagement holes 36 via the second movement direction conversion mechanism (61g and 73p). Thereby, the first claw member 61 retracts against the second force by the spring 63, and the lock of the leg body 30 by the storage lock mechanism 60 is released. Then, the leg body 30, which the first force is applied to by the spring 50, rotates from the storage position P1 to the upright position P2. When the user releases his or her hand from the push switch portion 71, the raising operation member 70 moves in the direction opposite to the push direction D7 by the second force applied by the spring 63, and the first claw member 61 moves in the advancing direction D6 via the second movement direction conversion mechanism (61g and 73p). That is to say, when the operation of the push switch portion 71 is released, the first claw member 61 advances.

As shown in FIGS. 11A to 11C, when the leg body 30 moves toward the storage position P1, first, the tip end part 32 of the leg body 30 contacts the inclined parts 62. This causes the tip end parts 61t of the first claw member 61 to retract against the second force by the spring 63. The changes in the leg body 30, the storage lock mechanism 60, and the raising operation member 70 at this time are shown in FIGS. 11A and 11B. When the tip end parts 61t of the first claw member 61 get over the leg body 30, the tip end parts 61t advance by the second force applied by the spring 63 and enter the engagement holes 36 of the leg body 30, as shown in FIG. 11C. Thus, each of the inclined parts 62 has the shape that causes the first claw member to retract and then advance by the second force applied by the spring 63 when the leg body 30 rotates from the upright position P2 to the storage position P1.

From the above operation, when the leg body 30 rotates from the upright position P2 to the storage position P1, the storage lock mechanism 60 releasably locks the leg body 30 at the storage position P1.

### (3) Example of Switching States of Deck Board

First, an example of switching the deck board 1 from the non-use state to the use state will be described.

When the rear board body 22 is at the non-use positions P4 or P5 shown in FIGS. 2, 3A, etc., the deck board 1 is in the non-use state. It is assumed that the left and right leg bodies 30 are at the storage position P1. In this non-use state, when the user performs the push operation on the left and right push switch portions 71 with his or her finger, each of the locks of the leg bodies 30 by the storage lock mechanism 60 is released, and each of the leg bodies 30 automatically rotates from the storage position P1 to the upright position P2 by the first force applied by the spring 50. When the user manually holds the rear board body 22 with the left and right leg bodies 30 erected and rotates the rear board body 22 rearward with his or her hand, the tip end parts 32 of the left and right leg bodies 30 enter the recesses 131 of the floor board 130 and are locked to the floor board 130 by the floor lock mechanism 40 as shown in FIGS. 8A to 8C. Thereby, the rear board body 22 is supported by the left and right leg bodies 30 at the use position P3, and the deck board 1 gets in the use state. Thus, the user can quickly switch the deck board 1 from the non-use state to the use state.

When the deck board 1 is in the use state, the user can place luggage on the floor board 130 and can also place luggage on the deck board 1. When the seat 120 is folded forward, the user can place large luggage from the back surface 121 of the seat 120 to the placement surface 11 of the deck board body 10.

Next, an example of switching the deck board 1 from the use state to the non-use state will be described.

When the rear board body 22 is at the use position P3 shown in FIGS. 1, 3B, etc., the deck board 1 is in the use state. It is premised that the left and right leg bodies 30 are at the upright position P2. In this use state, when the user slides the left and right floor lock release operation members 80 upward with his or her finger, each of the locks of the leg bodies 30 by the floor lock mechanism 40 is released. If the fourth energizing portion 90 has the fourth force to rotate the rear board body 22 upward from the use position P3, the rear board body 22 automatically rotates from the use position P3 to the non-use positions P4 or P5. Alternatively, the user may manually hold the rear board body 22 and rotate the rear board body 22 upward with his or her hand. By the fourth energizing portion 90 applying the fourth force to the rear board body 22 in the direction to rotate upward from the use position P3, the rear board body 22 is held at the non-use positions P4 or P5, and the deck board 1 is maintained in the non-use state. Furthermore, when the user manually holds the leg bodies 30 and rotates the leg bodies 30 from the upright position P2 to the storage position P1 with his or her hand, the leg bodies 30 are locked at the storage position P1 by the storage lock mechanism 60 as shown in FIGS. 11A to 11C. Thus, the user can quickly switch the deck board 1 from the use state to the non-use state.

When the deck board 1 is in the non-use state, the user can place luggage up to the ceiling height on the floor board 130.

By the leg bodies 30 being at the storage position P1, the leg bodies 30 do not interfere with luggage storage. Furthermore, when the leg bodies 30 are at the storage position P1, the storage surfaces 33 of the leg bodies 30 face the back surface 12 of the deck board body 10. This causes the floor lock release operation members 80 and the like to be hidden. Thus, the appearance of the back surface 12 of the deck board 1 in the non-use state is good.

As described above, the present deck board 1 can be quickly switched from the non-use state to the use state, and can also be quickly switched from the use state to the non-use state.

### (4) Modified Examples

Various modified examples of the present invention are available.

Although the above-described deck board 1 comprises the left and right leg bodies 30, the number of leg bodies included in the deck board may be one, or may be three or more. If the deck board has one leg body, this leg body can support the deck board body at the use position separated from the floor of the luggage compartment.

The second energizing portion that applies the second force to advance the first claw part is not limited to the spring 63 between the bezel 13 and the push switch portion 71. For example, the second energizing portion may be a spring or the like that contacts the first claw member 61 and applies the second force to he first claw member 61.

The third energizing portion that applies the third force to advance the second claw part is not limited to the spring 43 between the case 34 and the interlocking member 44. For example, the third energizing portion may be a spring or the like that contacts the second claw member 41 and applies the third force to advance the second claw member 41.

Although the above-described back surface 12 of the deck board body 10 had the recess 14, even if the back surface 12 does not have the recess 14, the storage surface 33 of the leg body 30 will face the back surface 12 when the leg body 30 is at the storage position P1.

It should be noted that even if the deck board body 10 is not divided into the front board body 21 and the rear board body 22, the effect of being able to quickly switch the state of the deck board 1 can be obtained. If the lock of the leg body 30 by the floor lock mechanism 40 is released by the operation of pulling up the leg body 30 from the floor board 130, the deck board 1 may not have the floor lock release operation portion. If the lock of the leg body 30 by the storage lock mechanism 60 is released by the operation of pulling out the leg body 30 from the storage position P1, the deck board 1 may not have the raising operation portion.

Even if the deck board 1 does not have at least one of the spring 50, the storage lock mechanism 60, and the fourth energizing portion 90, the effect of being able to quickly switch the deck board 1 from the non-use state to the use state by the floor lock mechanism 40 can be obtained. Alternatively, even if the deck board 1 does not have the floor lock mechanism 40, the effect of being able to quickly switch the deck board 1 from the non-use state to the use state by the spring 50, the storage lock mechanism 60, and the raising operation portion can be obtained.

### (5) Conclusion

As explained above, according to the present invention, through various embodiments, configurations of the vehicle deck board and the like that can be quickly switched from the non-use state to the use state can be provided. Of course, configurations consisting of the components in each independent claim can produce the above-mentioned primary operation and effect.

It is also possible to implement configurations formed by exchanging or combining the components disclosed in the above-mentioned examples with each another, configurations formed by exchanging or combining components in related art and the components disclosed in the above-mentioned examples with each another, etc. The present invention implies these configurations and the like.

Finally, names corresponding to reference signs are listed as follows:
1 . . . deck board, 2 . . . leg member,
10 . . . deck board body, 11 . . . placement surface, 12 . . . back surface, 13 . . . bezel, 14 . . . recess,
15 . . . positioning protrusion, 18 . . . shaft,
20 . . . hinge portion, 21 . . . front board body, 21b . . . back surface, 22 . . . rear board body,
30 . . . leg body, 31 . . . base end part, 31a . . . positioning part, 32 . . . tip end part, 33 . . . storage surface,
34 . . . case, 35 . . . groove, 36 . . . engagement hole,
40 . . . floor lock mechanism,
41 . . . second claw member (example of second claw part), 41a . . . side surface, 41g . . . groove, 41t . . . tip end part,
42 . . . inclined part,
43 . . . spring (example of third energizing portion), 43a . . . fixed end, 43b . . . movable end,
44 . . . interlocking member, 44a . . . extension part, 44p . . . protrusion, 45 . . . transmission member,
50 . . . spring (example of first energizing portion),
60 . . . storage lock mechanism,
61 . . . first claw member (example of first claw part), 61a . . . side surface, 61g . . . groove, 61t . . . tip end part,
62 . . . inclined part,
63 . . . spring (example of second energizing portion), 63a . . . fixed end, 63b . . . movable end,
70 . . . raising operation member, 71 . . . push switch portion (example of raising operation portion),
72 . . . base part, 73 . . . connecting part, 73p . . . protrusion,
80 . . . floor lock release operation member (example of floor lock release operation portion),
90 . . . fourth energizing portion, 91 . . . cover, 92 . . . shaft, 93 . . . spring,
100 . . . automobile (example of vehicle),
130 . . . floor board, 131 . . . recess, 132 . . . engagement hole, 140 . . . tool box,
AX1 . . . rotation axis,
D1 . . . front-rear direction, D2 . . . up-down direction, D3 . . . vehicle width direction,
D4 . . . extension direction, D5, D6 . . . advancing direction, D7 . . . push direction,
LR1 . . . luggage compartment,
P1 . . . storage position, P2 . . . upright position, P3 . . . use position, P4, P5 . . . non-use position.

What is claimed is:

1. A vehicle deck board to be disposed in a luggage compartment of a vehicle, the vehicle deck board comprising:
a deck board body having a placement surface for luggage, the deck board body having a back surface opposite to the placement surface;
a leg body having a base end part rotatably connected to the deck board body around a rotation axis along the back surface, the leg body having a tip end part on a side opposite to the base end part, the leg body being rotatable between a storage position along the back surface and an upright position erected from the back surface; and
a floor lock mechanism located at the tip end part of the leg body, the floor lock mechanism being configured to releasably lock the leg body to the floor when the leg body at the upright position is placed on a floor of the luggage compartment.

2. The vehicle deck board according to claim 1, further comprising:
a first energizing portion applying a rotatable first force to the leg body from the storage position to the upright position;
a storage lock mechanism configured to releasably lock the leg body at the storage position; and
a raising operation portion releasing the lock of the leg body by the storage lock mechanism when the raising operation portion is operated.

3. The vehicle deck board according to claim 2, wherein:
the storage lock mechanism includes:
a first claw part configured to catch on the leg body when advanced and allows rotation of the leg body when retracted; and
a second energizing portion applying a second force to advance the first claw part, wherein
the first claw part retracts against the second force by the second energizing portion when the raising operation portion is operated,
the first claw part advances by the second force applied by the second energizing portion when operation of the raising operation portion is released, and
the first claw part has a shape that causes the first claw part to retract and then advance by the second force applied by the second energizing portion when the leg body rotates from the upright position to the storage position.

4. The vehicle deck board according to claim 1, wherein
the leg body has a storage surface that faces the back surface of the deck board body when the leg body is at the storage position, and
the vehicle deck board further comprises a floor lock release operation portion located on the storage surface, the floor lock release operation portion releasing the lock of the leg body by the floor lock mechanism when the floor lock release operation portion is operated.

5. The vehicle deck board according to claim 4, wherein:
the floor lock mechanism includes:
a second claw part configured to catch on the floor when advanced and release the leg body from the floor when retracted; and
a third energizing portion applying a third force to advance the second claw part, wherein
the second claw part retracts against the third force by the third energizing portion when the floor lock release operation portion is operated,
the second claw part advances by the third force applied by the third energizing portion when operation of the floor lock release operation portion is released, and
the second claw part has a shape that causes the second claw part to retract and then advance by the third force applied by the third energizing portion when the leg body at the upright position is placed on the floor.

6. The vehicle deck board according to claim 1, wherein
the deck board body includes a rear board body that the leg body is connected to, a front board body that is in front of the rear board body, and a hinge portion,
the rear board body and the front board body are connected via the hinge portion to be capable of bending operation,
the front board body is configured to be fixed to the vehicle in the luggage compartment,
the vehicle deck board is configured to be disposed at a use position where the back surface of the rear board body faces downward, and
the vehicle deck board further comprises a fourth energizing portion that applies a fourth force in a direction to rotate the rear board body upward from the use position, with the hinge portion as a base point.

7. A vehicle deck board to be disposed in a luggage compartment of a vehicle, the vehicle deck board comprising:
a deck board body having a placement surface for luggage, the deck board body having a back surface opposite to the placement surface;
a leg body rotatably connected to the deck board body around a rotation axis along the back surface, the leg body being rotatable between a storage position along the back surface and an upright position erected from the back surface;
a first energizing portion applying a rotatable first force to the leg body from the storage position to the upright position;
a storage lock mechanism configured to releasably lock the leg body at the storage position; and
a raising operation portion releasing the lock of the leg body by the storage lock mechanism when the raising operation portion is operated.

8. A leg member for a vehicle deck board, the leg member including a deck board body having a placement surface for luggage, the deck board body having a back surface opposite to the placement surface, the leg member comprising:
a leg body having a base end part to be rotatably connected to the deck board body around a rotation axis along the back surface, the leg body having a tip end part on a side opposite to the base end part, the leg body being configured to be rotatable between a storage position along the back surface and an upright position erected from the back surface; and
a floor lock mechanism located at the tip end part of the leg body, the floor lock mechanism being configured to releasably lock the leg body to the floor when the leg body at the upright position is placed on a floor of a luggage compartment.
